(19) United States
(12) Patent Application Publication
(10) Pub. No.: US 2013/0093677 A1
(43) Pub. Date: Apr. 18, 2013

(54) Ergonomic Computer Mouse

(71) Applicant: Marcel Cabrera, Miami, FL (US)

(72) Inventor: Marcel Cabrera, Miami, FL (US)

(21) Appl. No.: 13/272,214

(22) Filed: Oct. 12, 2011

(51) Int. Cl. G06F 3/033

(52) U.S. Cl. 345/163

(57) ABSTRACT

A substantially flat, lightweight computer mouse that provides ergonomic relief for the wrist and finger joints. The computer mouse is efficacious in alleviating wrist and finger joint pain because of its extremely thin, lightweight design and the longitudinal positioning of its flat buttons.

### BACKGROUND

The present invention is directed to a flat, ergonomically designed computer mouse that provides a mouse that can be manipulated simply by using the natural curvature of the fingers of a user's hand.

The present invention is a device that will help individuals that suffer from carpal tunnel syndrome and arthritis. The use of a computer mouse at work causes a strain on the wrist and finger joints of the user. The afflicted can only work with mice for short periods of time. Reason, The mice are either too thick or the buttons are positioned at awkward angles that make clicking the buttons difficult.

The inventor noticed that his wrist and finger joints always felt comfortable when he rested them on a flat surface. He also noticed that sliding his hand across a flat surface had a therapeutic, massaging effect on his wrist and finger joints.

The inventor reasoned that an ergonomic mouse had to be substantially flat and that the mouse buttons had to be lined up along a longitudinal axis.

The inventor then reasoned that he needed to make his invention light weight. He researched as to how he could minimize the weight effect. Upon trial and error he stumbled on an article that informed him that Thermoformed plastic and Styrofoam were two very light material that were rigid enough to withstand daily use for hand held devices. He further recognized that the computer mouse had to be wireless using known means in the art of Mice.

In the past, ergonomic devices in the office setting have been used to alleviate pain of the back, neck, and limbs. The inventor of this present invention believes that a computer mouse configured ergonomically will help the afflicted with carpal tunnel syndrome and arthritis.

An ergonomic computer mouse has been used for computing in the past, yet none with the present characteristics of the present invention. See U.S. Pat. Nos. 7,948,474, 7,705,827, 5,726,683, D529,504, and D495,711.

For the foregoing reasons, there is a need for an ergonomic computer mouse that will alleviate wrist and finger joint pain, that is lightweight, and that will wirelessly communicate with a computing device efficiently and accurately.

### SUMMARY

The present invention is directed to an ergonomic computer mouse that will alleviate wrist and finger joint pain, that is lightweight, and that will communicate wirelessly with a computing device, efficiently and accurately.

The present invention is a substantially flat, lightweight computer mouse that provides ergonomic relief for the wrist and finger joints of a user. The computer mouse is efficacious in alleviating wrist and finger joint pain because of its extremely thin, lightweight structure and the longitudinal positioning of its flat buttons. In some embodiments of the present invention, the computer mouse will have a width in the range of one eighth of an inch to one quarter of an inch. The computer mouse's outer shell may be fabricated from Thermoformed plastic films and the inner core from Styrofoam; in this embodiment, the materials would be chosen to minimize weight. In this embodiment at least two buttons would be positioned on the upper surface of the mouse along a longitudinal axis, and the mouse would be substantially flat. The positioning system of the mouse is comprised of a positioning devise built into the base for orienting the position of the computer mouse. The positioning device is adapted to be operatively connected to the computing device via a radio frequency transmitter integrated into the mouse and a USB receiver in the computing device. The ergonomic computer mouse is used by people who work with computing devices for many hours and people who suffer from carpal tunnel syndrome and arthritis. It is made to relieve pain while utilizing a computer mouse.

An object of the present invention is to provide a computer mouse that will minimize the strain on wrists and finger joints.

Another object of the present invention is to provide a computer mouse that will allow a user to work on a computing device such as a computer for many hours without feeling fatigue in the wrist or finger joints.

Yet another object of the present invention is to provide a computer mouse that will help user's that suffer from carpal tunnel syndrome or arthritis.

A further object of the present invention is to provide a computer mouse that will, both accurately and efficiently, communicate with a computing device.

### DRAWINGS

These and other features, aspects, and advantages of the present invention will become better understood with regard to the following description, appended claims, and drawings where:

FIG. 1 is a perspective view of the present invention; and

FIG. 2 is a bottom plan view of the base of the present invention.

### DESCRIPTION

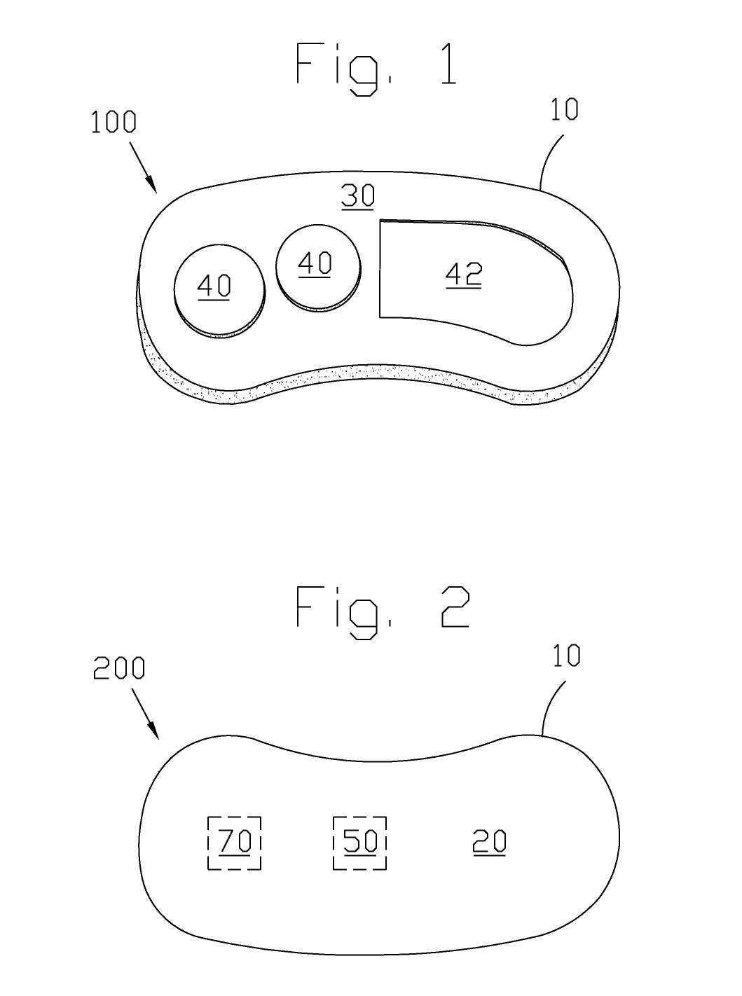

As seen in FIG. 1-2, a substantially flat ergonomically configured computer mouse for use with a computing device, the computer mouse 100 comprises a mouse body 10 having a substantially flat planar base 20, for sliding movement along a supporting surface, and a substantially flat planar upper surface 30, the flat planar upper surface defines a finger support area 42. The mouse further comprises of at least one command button 40 defined on the flat planar upper surface 30 of the mouse body 10 that is adjacent to the finger support area 42, each command button 40 is operable by one or more clicking actions for performing actions on the computing device. The mouse 100 further comprises of a positioning device 50. The positioning device is a movement sensor module for orienting the tracking of the mouse. The positioning device is housed in the mouse body 10.

In one embodiment of the present invention the mouse body will be substantially bean shaped 200, the bean shape follows the natural curvature of the outstretched fingertips of a user's hand.

In a further embodiment of the present invention, the width of the mouse will be between at least about one sixteenth of an inch and about one quarter of an inch.

In a further embodiment of the present invention, the computer mouse 100 is operatively connected to the computing device via a wireless transmitter 70 that is housed within the mouse body 10. The computer mouse 100 sends signals from the wireless radio transmitter to a computing device. The computer mouse 100 records its movements from the positioning device 50 and buttons 40 that are clicked, and then sends this information via radio frequency signals to the computing device.

In a further embodiment of the present invention, the computer mouse's 100 outer shell is fabricated from Thermoformed plastic films and the inner core from Styrofoam to minimize weight.

An advantage of the present invention is that it minimizes the strain on wrists and finger joints while using a computing device for extended periods of time.

Another advantage of the present invention is that shipping costs are minimized due to its light weight and small dimensions.

Yet another advantage to this present invention is that it is aesthetically pleasing.

Although the present invention has been described in considerable detail in reference to preferred versions, other versions are possible. Therefore, the spirit and scope of the appended claims should not be limited to the description of the preferred versions contained herein.

What is claimed is:

1. A substantially flat ergonomically configured computer mouse for use with a computing device, the computer mouse comprising:
a mouse body having a substantially flat planar base for sliding movement along a supporting surface, and a substantially flat planar upper surface, the flat planar upper surface defines a finger support area;
at least one command button defined on the upper surface of the mouse body, the command button(s) is/are adjacent to the finger support area; and
a positioning device, the positioning device is a movement sensor module for orienting the tracking of the mouse and is housed in the mouse body.

2. The computer mouse of claim 1, further comprising of a wireless transmitter, the wireless transmitter is housed within the mouse body.

3. The computer mouse of claim 1, wherein the mouse body is substantially bean shaped, the bean shape follows the natural curvature of the outstretched fingertips of a user's hand.

4. The computer mouse of claim 1, wherein a mouse's width is at least about one sixteenth of an inch to about one quarter of an inch.

5. The computer mouse of claim 1, wherein the mouse body outer casing is a Thermoformed plastic film and the mouse body core is a Styrofoam material.
